(19) United States
(12) Patent Application Publication
(10) Pub. No.: US 2019/0350782 A1
(43) Pub. Date: Nov. 21, 2019

(54) Ladder chair capable of climbing stairs

(71) Applicant: Long-Wei WANG, Taichung City (TW)

(72) Inventor: Long-Wei WANG, Taichung City (TW)

(21) Appl. No.: 15/980,758

(22) Filed: May 16, 2018

(51) Int. Cl. A61G 5/06; B62D 55/04; B62D 55/084

(52) U.S. Cl. CPC A61G 5/061; B62D 55/084; B62D 55/04; A61G 5/066

(57) ABSTRACT

A ladder chair contains: a body, a continuous track assembly, and a lifting mechanism. The body includes a sitting portion arranged on a top thereof and a pedal extending outward from a bottom of the body. The climbing assembly is arranged on a rear end of the body. The lifting mechanism is located behind the body and the sitting portion, and the lifting mechanism includes two telescopic posts and two rollers individually disposed on two bottoms of the two telescopic posts. The climbing assembly includes two continuous tracks arranged on two peripheral sides thereof respectively and obliquely extending upward relative to the body, a transmission shaft mounted on a bottom of the climbing assembly, two idlers respectively fixed on two tops of the two continuous tracks. Each continuous track is defined between the transmission shaft and each idler and is driven by the transmission shaft to rotate.

### FIELD OF THE INVENTION

The present invention relates to a ladder chair which is capable of climbing stairs.

### BACKGROUND OF THE INVENTION

A conventional ladder chair is applied to climb stairs upward or downward, but it has defects as follows:

1. The conventional ladder chair and its transmission structure are fixed on the stairs in a fixed direction, so user has to turns and to move onto a seat of the ladder chair.

2. The conventional ladder chair occupies space beside the stairs.

The present invention has arisen to mitigate and/or obviate the afore-described disadvantages.

### SUMMARY OF THE INVENTION

The primary aspect of the present invention is to provide a ladder chair which is capable of climbing stairs randomly.

Another aspect of the present invention is to provide a ladder chair which keeps user sitting on the sitting portion of the body securely as climbing stairs upward or downward.

To obtain above-mentioned aspects, a ladder chair provided by the present invention contains: a body, a continuous track assembly, and a lifting mechanism.

The body includes a sitting portion arranged on a top of the body, and the body includes a pedal extending outward from a bottom of the body.

The climbing assembly is arranged on a rear end of the body.

The lifting mechanism is located behind the body and the sitting portion, and the lifting mechanism includes two telescopic posts and two rollers individually disposed on two bottoms of the two telescopic posts.

The climbing assembly includes two continuous tracks arranged on two peripheral sides thereof respectively and obliquely extending upward relative to the body, a transmission shaft mounted on a bottom of the climbing assembly, two idlers respectively fixed on two tops of the two continuous tracks, wherein each of the two continuous track is defined between the transmission shaft and each of the two idlers and is driven by the transmission shaft to rotate.

The body and the lifting mechanism include multiple sensors mounted on bottoms thereof.

Preferably, two control bars are arranged on two sides of the transmission shaft individually, and each of the two control bars includes an auxiliary rotation roller disposed on a bottom of each control bar.

### BRIEF DESCRIPTION OF THE DRAWINGS

FIG. 1 is a side plan view showing the assembly of a ladder chair according to a preferred embodiment of the present invention.

FIG. 2 is a side plan view showing the assembly of the ladder chair according to the preferred embodiment of the present invention.

FIGS. 3-9 are a side plan view showing the operation of the ladder chair according to the preferred embodiment of the present invention.

FIGS. 10-13 are another side plan view showing the operation of the ladder chair according to the preferred embodiment of the present invention.

### DETAILED DESCRIPTION OF THE PREFERRED EMBODIMENTS

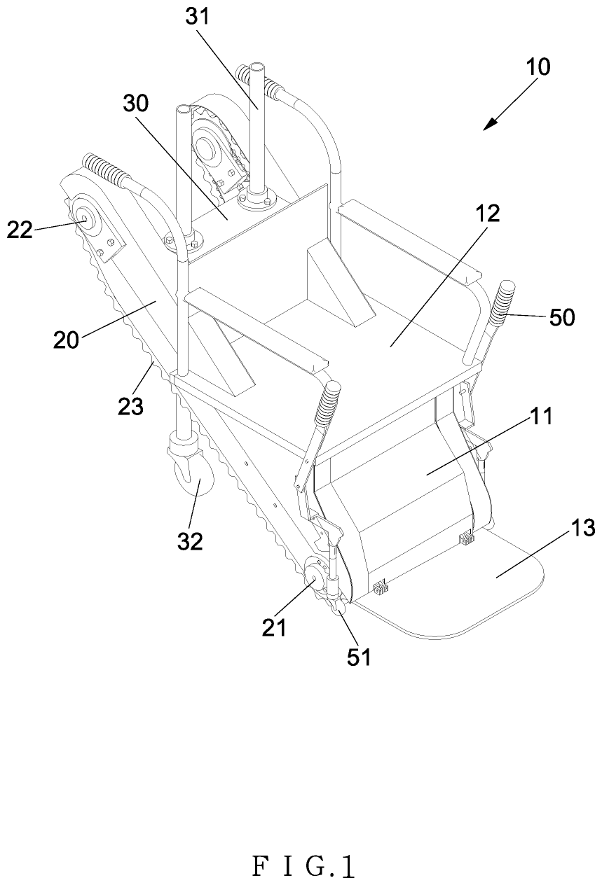

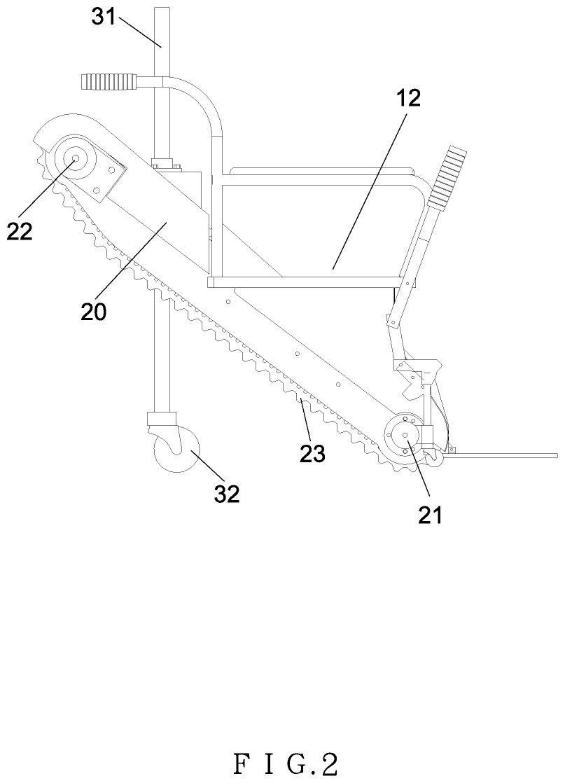

With reference to FIGS. 1-2, a ladder chair 10 according to a preferred embodiment of the present invention comprises: a body 11, a continuous track assembly 20, and a lifting mechanism 30.

The body 11 includes a sitting portion 12 arranged on a top thereof and includes a pedal 13 extending outward from a bottom of the body 11.

The climbing assembly 20 is arranged on a rear end of the body 11, and the climbing assembly 20 includes two continuous tracks 23 arranged on two peripheral sides thereof respectively and obliquely extending upward relative to the body 11, a transmission shaft 21 mounted on a bottom of the climbing assembly 20, two idlers 22 respectively fixed on two tops of the two continuous tracks 23, wherein each of the two continuous track 23 is defined between the transmission shaft 21 and each of the two idlers 22 and is driven by the transmission shaft 21 to rotate.

The lifting mechanism 30 is located behind the body 11 and the sitting portion 12, and the lifting mechanism 30 includes two telescopic posts 31 and two rollers 32 individually disposed on two bottoms of the two telescopic posts 31.

Furthermore, the body 11 and the lifting mechanism 30 include multiple sensors (not shown) mounted on bottoms of the body 11 and the lifting mechanism 30.

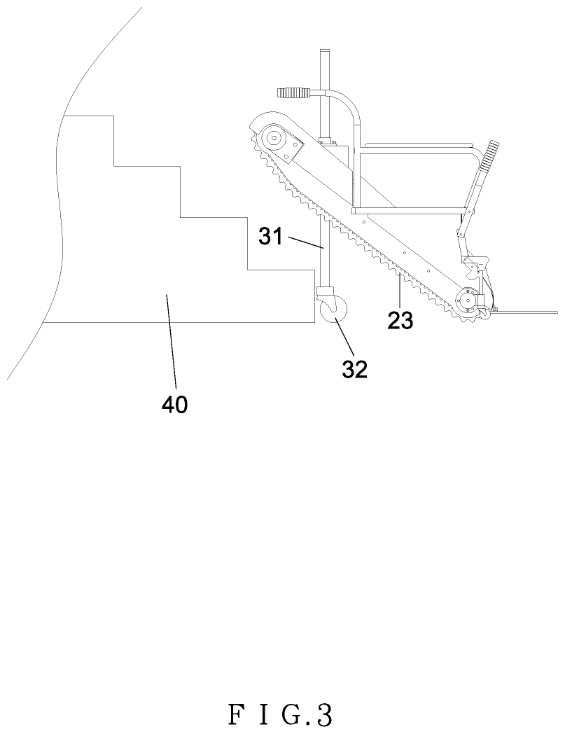

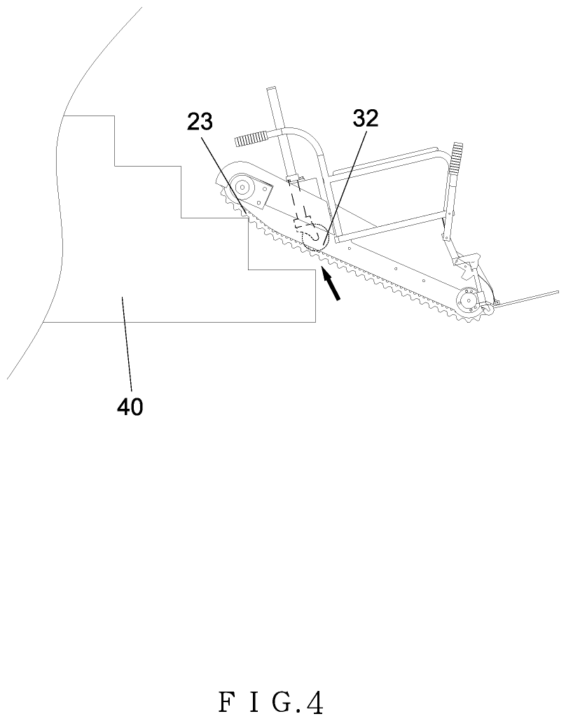

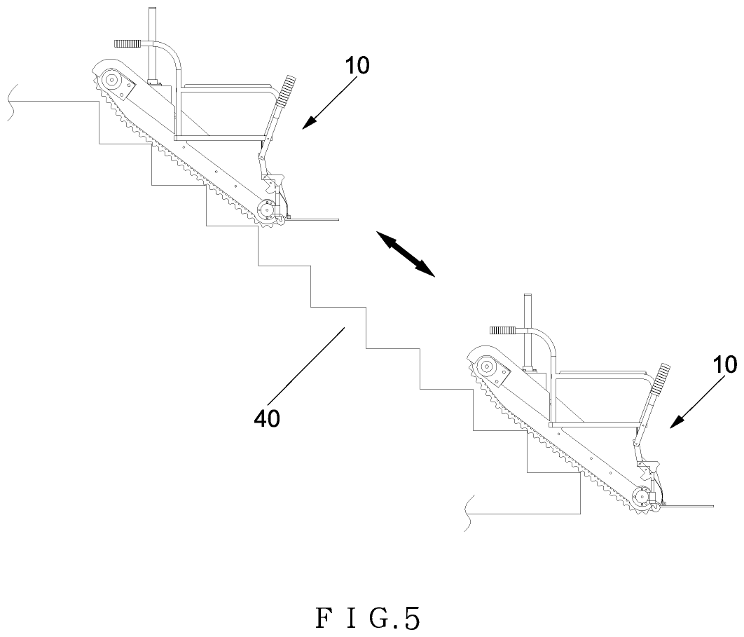

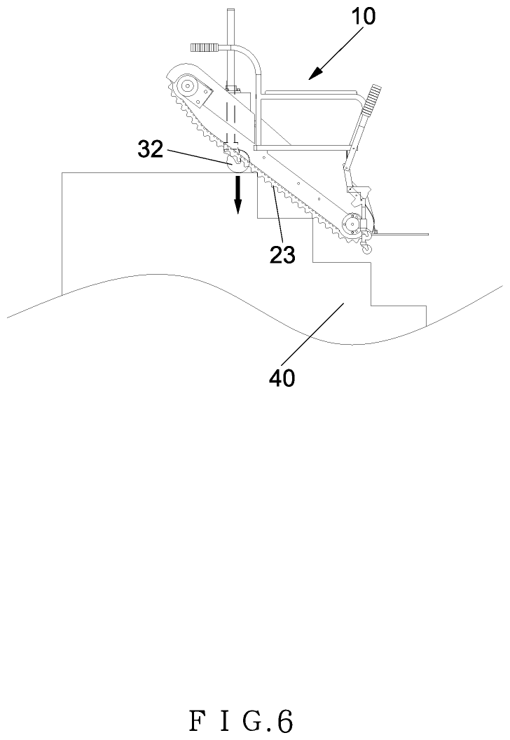

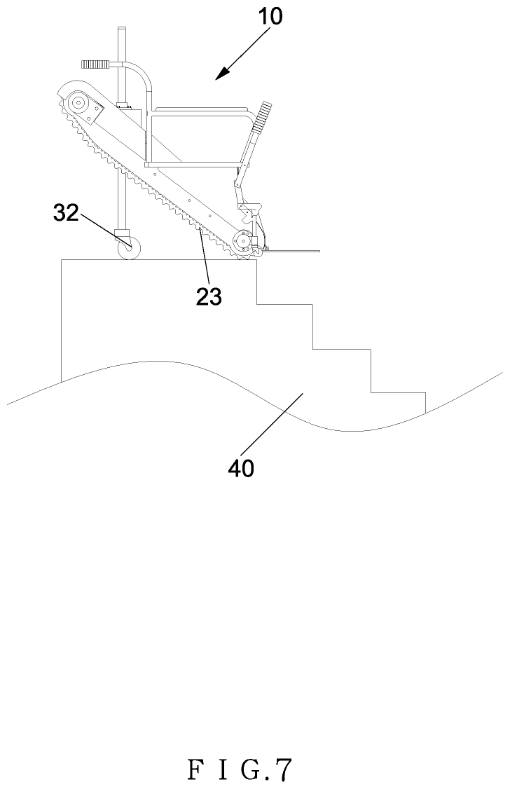

Referring to FIGS. 3-7, when the ladder chair does not climb up stairs 40, the two rollers 32 descend to flush with the transmission shaft 21. As desiring to climb up the stairs 40, the two rollers 32 of the lifting mechanism 30 trigger the multiple sensors, when moving close to the stairs 40, such that the multiple sensors control the two telescopic posts 31 to retract upward so that the ladder chair 10 falls backward to contact with the stairs 40 by way of the two continuous tracks 23, and the continuous tracks 23 actuate the ladder chair 10 to climb up the stairs 40. After the ladder chair 10 climbs up to a top of the stairs 40, the multiple sensors control the two rollers 32 to drop and to climb up to the top of the stairs 40, and user sits on the sitting portion 12 of the ladder chair 10 securely.

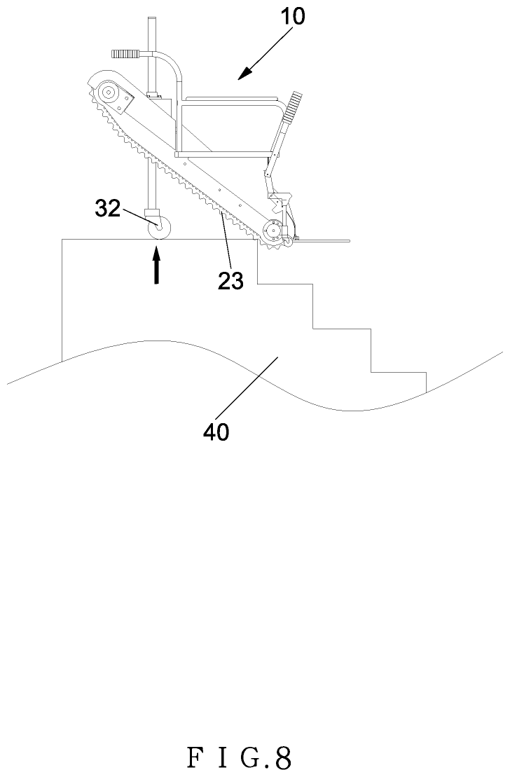

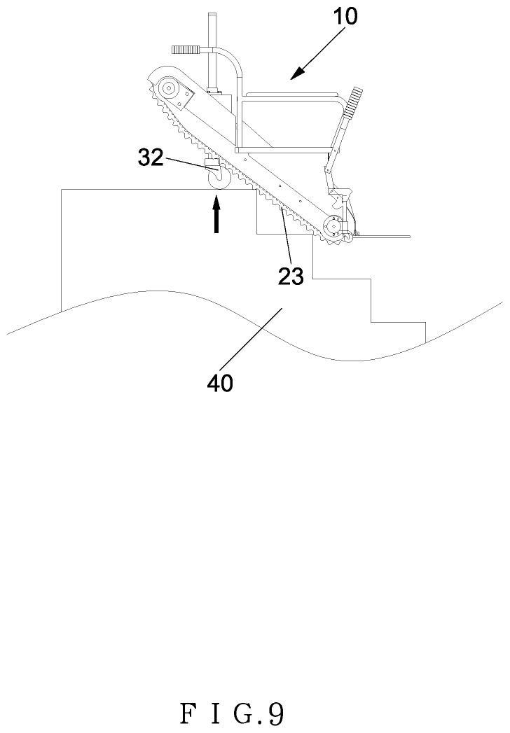

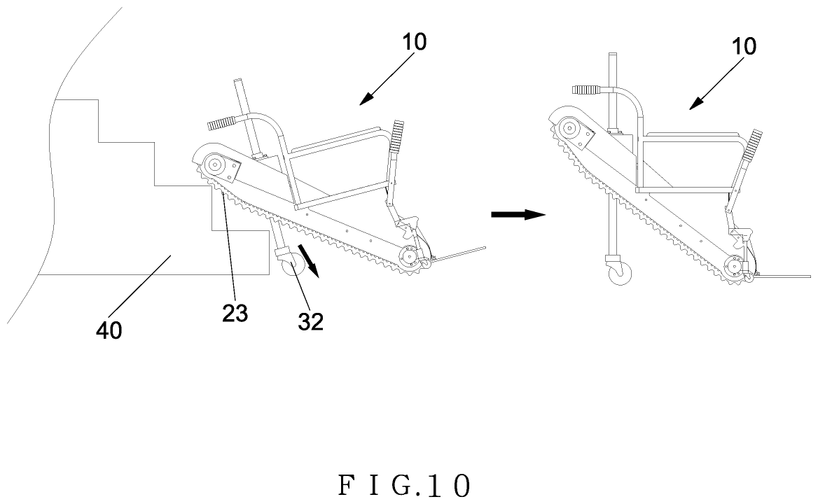

As shown in FIGS. 8-10, when the ladder chair 10 climbs down the stairs 40, the transmission shaft 21 drives each continuous track 23 to climb down the stairs 40, and the multiple sensors control the two telescopic posts 31 to retract upward so that the ladder chair 10 goes down the stairs 40 stably. After the ladder chair 10 goes down to a ground from the stairs 40, the multiple sensors control the two rollers 32 to descend onto the ground, hence the ladder chair 10 erects on the ground securely by using the two rollers and the two continuous tracks.

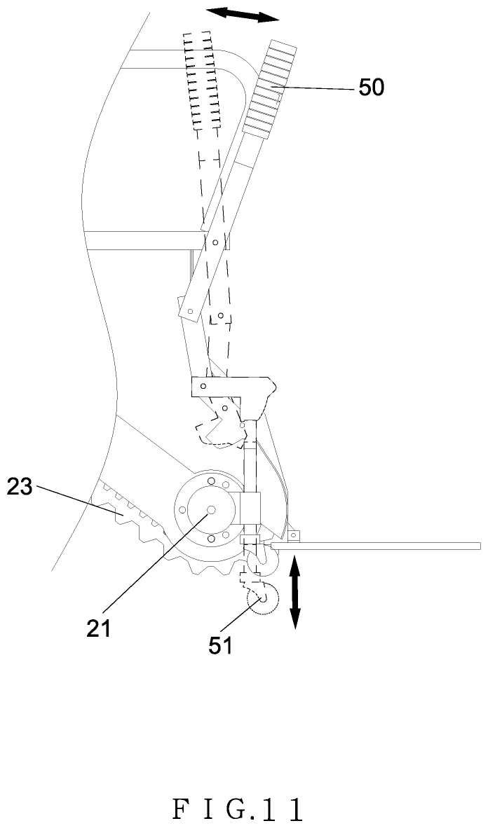

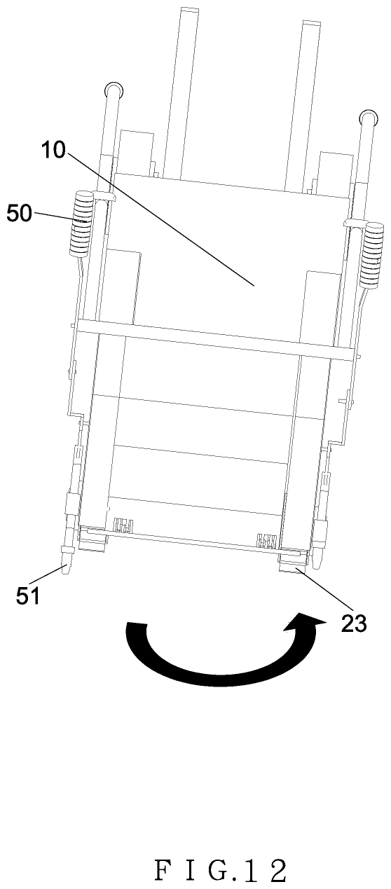

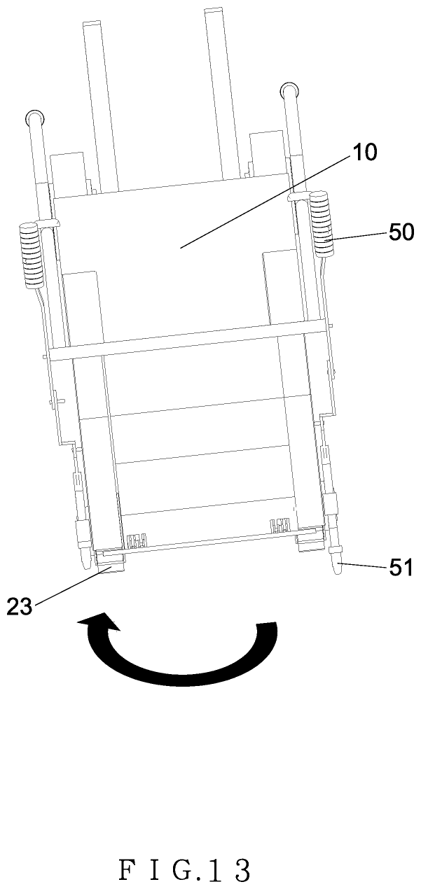

As illustrated in FIGS. 11-13, two control bars 50 are arranged on two sides of the transmission shaft 21 individually, and each of the two control bars 50 includes an auxiliary rotation roller 51 disposed on a bottom of each control bar 50 so that when each control bar 50 is pushed forward or is pulled backward, the auxiliary rotation roller 51 is controlled to rotatably lift or descend toward a desired direction and to actuate each continuous track 23 to rotatably move away from the ground, then the ladder chair 10 rotates toward the same direction as each continuous track 23.

While the preferred embodiments of the invention have been set forth for the purpose of disclosure, modifications of the disclosed embodiments of the invention and other embodiments thereof may occur to those skilled in the art. Accordingly, the appended claims are intended to cover all embodiments which do not depart from the spirit and scope of the invention.

What is claimed is:

1. A ladder chair comprising:
a body including a sitting portion arranged on a top of the body, and the body including a pedal extending outward from a bottom of the body;
a climbing assembly arranged on a rear end of the body;
a lifting mechanism located behind the body and the sitting portion, and the lifting mechanism including two telescopic posts and two rollers individually disposed on two bottoms of the two telescopic posts;
wherein the climbing assembly includes two continuous tracks arranged on two peripheral sides thereof respectively and obliquely extending upward relative to the body, a transmission shaft mounted on a bottom of the climbing assembly, two idlers respectively fixed on two tops of the two continuous tracks, wherein each of the two continuous track is defined between the transmission shaft and each of the two idlers and is driven by the transmission shaft to rotate;
wherein the body and the lifting mechanism include multiple sensors mounted on bottoms thereof; and
wherein two control bars are arranged on two sides of the transmission shaft individually, and each of the two control bars includes an auxiliary rotation roller disposed on a bottom of each control bar.

2. The ladder chair as claimed in claim 1, wherein when the ladder chair does not climb up stairs, the two rollers descend to flush with the transmission shaft.

3. The ladder chair as claimed in claim 1, wherein when the ladder chair climbs up the stairs, the two rollers of the lifting mechanism trigger the multiple sensors, and the multiple sensors control the two telescopic posts to retract upward so that the ladder chair falls backward to contact with the stairs by way of the two continuous tracks, and the continuous tracks actuate the ladder chair to climb up the stairs; after the ladder chair climbs up to a top of the stairs, the multiple sensors control the two rollers to drop until the ladder chair does not climb the stairs.

4. The ladder chair as claimed in claim 1, wherein when the ladder chair climbs down the stairs, the transmission shaft drives each continuous track to climb down the stairs, and the multiple sensors control the two telescopic posts to retract upward so that the ladder chair goes down the stairs; after the ladder chair goes down to a ground from the stairs, the multiple sensors control the two rollers to descend onto the ground, hence the ladder chair erects on the ground.

5. The ladder chair as claimed in claim 1, wherein when each control bar is pushed forward or is pulled backward, the auxiliary rotation roller is controlled to rotatably lift or descend toward a desired direction.

6. The ladder chair as claimed in claim 1, wherein the auxiliary rotation roller is controlled to rotatably descend toward a desired direction and to actuate each continuous track to rotatably move away from the ground, then the ladder chair rotates toward the same direction as each continuous track.
